(19) United States
(12) Patent Application Publication
(10) Pub. No.: US 2021/0119513 A1
(43) Pub. Date: Apr. 22, 2021

(54) ELECTRIC MOTOR AND VENTILATING FAN

(71) Applicant: Mitsubishi Electric Corporation, Chiyoda-ku, Tokyo (JP)

(72) Inventors: Junji OKADA, Tokyo (JP); Junichi OZAKI, Tokyo (JP); Takuya NAKAMURA, Tokyo (JP); Masahiro KATO, Tokyo (JP)

(73) Assignee: Mitsubishi Electric Corporation, Chiyoda-ku, Tokyo (JP)

(21) Appl. No.: 17/047,488

(22) PCT Filed: May 21, 2018
(86) PCT No.: PCT/JP2018/019544

§ 371 Date: Oct. 14, 2020

(51) Int. Cl. H02K 9/22; H02K 9/06; H02K 11/33

(52) U.S. Cl. CPC H02K 9/227; H02K 2211/03; H02K 11/33; H02K 9/06

(57) ABSTRACT

An electric motor includes a frame and a bracket to constitute an outer case, a stator having a cylindrical shape accommodated in the frame, a rotor arranged inner side of the stator, a circuit board placed on a side of the stator which is close to the bracket, a heat-generating component mounted on the circuit board, and a heat sink mounted on the circuit board and thermally connected to the heat-generating component, wherein a first heat-radiating adhesive layer, an insulating sheet, and a second heat-radiating adhesive layer are arranged between the bracket and the heat sink in this order from a side close to the heat sink, and the bracket and the heat sink are thermally connected to each other.

### FIELD

The present invention relates to an electric motor including a circuit board on which an electronic component that generates heat is mounted, and a ventilating fan in which a blower fan is driven to rotate by the electric motor.

### BACKGROUND

A ventilating fan is provided with an electric motor that drives and rotates a blower fan. The electric motor of the ventilating fan includes a circuit board on which a heat-generating component is mounted in a bracket, and transfers heat generated in the heat-generating component during an operation to the bracket to radiate the heat.

Patent Literature 1 discloses an electric motor in which a heat-transfer component fixed to a bracket with screws is arranged to be in contact with a heat-generating component and transfers heat generated in the heat-generating component to the bracket.

### CITATION LIST

### Patent Literature

Patent Literature 1: Japanese Patent Application Laid-open No. 2015-144532

### SUMMARY

### Technical Problem

However, the electric motor disclosed in Patent Literature 1 described above includes a heat-dissipation sheet interposed between the heat-transfer component and the bracket. The heat-dissipation sheet may have pinholes formed in its manufacturing stage. Thus, an insulating component needs to be provided between the heat-transfer component and the heat-generating component. Therefore, in the electric motor disclosed in Patent Literature 1, the number of components is increased because a component for fixing the insulating component is required, and this causes increase of assembly man-hours. Furthermore, because the heat-dissipation sheet is soft and tends to tear, automatic assembly by an industrial robot is difficult.

The present invention has been achieved in view of the above problems, and an object of the present invention is to provide an electric motor that can prevent increase of the number of components and increase of assembly man-hours and can be assembled by automatic assembly.

### Solution to Problem

To solve the above problems and achieve the object, an electric motor according to the present invention includes: a frame and a bracket to constitute an outer case; a stator having a cylindrical shape accommodated in the frame; a rotor arranged inner side of the stator; a circuit board placed on a side of the stator which is close to the bracket; a heat-generating component mounted on the circuit board; and a heat sink mounted on the circuit board and thermally connected to the heat-generating component. A first heat-radiating adhesive layer, an insulating sheet, and a second heat-radiating adhesive layer are arranged between the bracket and the heat sink in this order from a side close to the heat sink, and the bracket and the heat sink are thermally connected to each other.

### Advantageous Effects of Invention

The electric motor according to the present invention has an effect where it is possible to prevent increase of the number of components and increase of assembly man-hours, and thus the electric motor can be assembled by automatic assembly.

### BRIEF DESCRIPTION OF DRAWINGS

FIG. 1 is a cross-sectional view of an electric motor according to a first embodiment of the present invention.

FIG. 2 is a partial enlarged view of the electric motor according to the first embodiment.

FIG. 3 is a cross-sectional view of a ventilating fan according to a second embodiment of the present invention.

### DESCRIPTION OF EMBODIMENTS

An electric motor and a ventilating fan according to embodiments of the present invention will be described in detail below with reference to the accompanying drawings. The present invention is not limited to the embodiments.

### First Embodiment

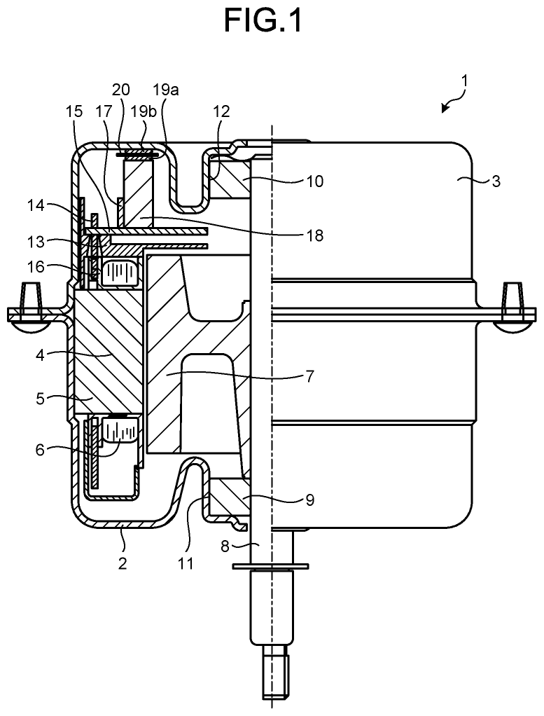

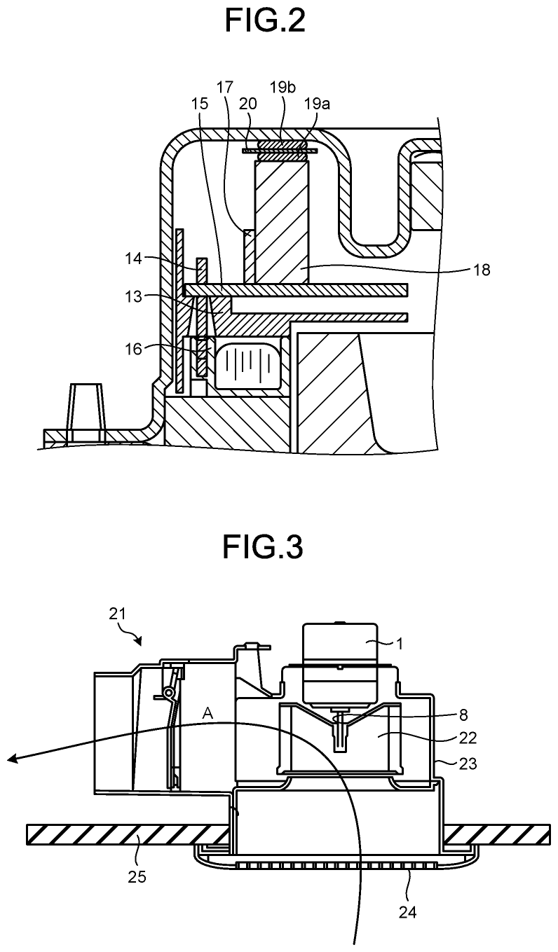

FIG. 1 is a cross-sectional view of an electric motor according to a first embodiment of the present invention. FIG. 2 is a partial enlarged view of the electric motor according to the first embodiment. An electric motor 1 according to the first embodiment is a DC brushless motor. In the electric motor 1, constituent elements are accommodated in an outer case that is formed by a frame 2 and a bracket 3. The frame 2 is in the form of a cylinder having the bottom and is made of metal. A stator 4 having a cylindrical shape is press-fitted into the frame 2. The stator 4 is formed by an iron core 5, an insulator 16, and a coil 6 wound around the iron core 5.

A rotor 7 having an annular shape is arranged inner side of the stator 4. A shaft 8 extending along a central axis of the stator 4 is coupled to the rotor 7. One end of the shaft 8 protrudes to outside of the frame 2.

The shaft 8 is axially supported by a first bearing 10 at a portion closer to the other end than a coupled portion at which the shaft 8 is coupled to the rotor 7, and is axially supported by a second bearing 9 at a portion closer to the one end than the coupled portion. The first and second bearings 10 and 9 support the shaft 8 in such a manner that the shaft 8 can rotate about the central axis of the stator 4. The second bearing 9 is held in a housing 11 formed in the frame 2. The first bearing is held in a housing 12 formed in the bracket 3.

A board case 13 is fixed to the stator 4 on the side of the bracket 3. A circuit board 15 is placed in the board case 13. Therefore, the circuit board 15 is placed on the side of the stator 4 which is close to the bracket 3. An output pin 14 inserted into a through-hole that is formed in the board case 13 protrudes toward a mounting surface of the board case 13, on which the circuit board 15 is mounted, and is electrically connected to the circuit board 15 by soldering. The output pin 14 may be electrically connected to the circuit board 15 with a method other than soldering. The diameters of an opening of the board case 13 and an opening of the circuit board 15 are larger than the outer diameter of the first bearing 10 on the bracket 3 side. The circuit board 15 is positioned in the axial direction by being brought into contact with an insulator 16 via the board case 13.

Various types of electronic components mounted on the circuit board 15 realize functions such as a driving unit, a control unit, and a power supply unit. The driving unit can be realized by a configuration using a three-phase bridge driver in which six discrete elements and an integrated circuit (IC) that forms a motor driver are combined with each other. A one-chip inverter IC or an insulated gate bipolar transistor (IGBT) can be applied to the discrete elements. A microcomputer can be applied to the control unit.

When external power is supplied to the power supply unit, the driving unit supplies power to the coil 6 and drives the coil 6 in response to a control command from the control unit, thereby generating a driving torque for rotating the rotor 7 in which a load is connected to the shaft 8. When power is supplied to the coil 6 and the coil 6 is driven, a part of the electronic components mounted on the circuit board 15 generates heat. That is, a part of the electronic components mounted on the circuit board 15 is a heat-generating component 17 that generates heat while being driven. The heat-generating component 17 forms the driving unit and the power supply unit.

The heat-generating component 17 is in contact with a heat sink 18 placed on the circuit board 15 and is thermally connected thereto. A first heat-radiating adhesive layer 19a, an insulating sheet 20, and a second heat-radiating adhesive layer 19b are interposed between a plane of the heat sink 18 on the bracket 3 side and the bracket 3, so that the bracket 3 and the heat sink 18 are thermally connected to each other. Therefore, the heat generated in the heat-generating component 17 is radiated to outside of the electric motor 1. The insulating sheet has a larger area than the top plane of the heat sink 18, and a creepage distance that insulates the bracket 3 and the heat sink 18 from each other is ensured.

A procedure of thermally connecting the bracket 3 and the heat sink 18 to each other is described. First, a heat-radiating adhesive is applied onto the top plane of the heat sink 18. Application of the heat-radiating adhesive is performed by a dispenser, and the position of application and the application amount are set in advance and are automatically managed. Next, the insulating sheet is placed on the heat-radiating adhesive. Subsequently, the heat-radiating adhesive is applied onto the insulating sheet 20 in an identical manner. When the bracket 3 is placed, the heat-radiating adhesive and the insulating sheet 20 are interposed between the bracket 3 and the heat sink 18. When the heat-radiating adhesive is hardened, the first heat-radiating adhesive layer 19a is formed between the heat sink 18 and the insulating sheet 20, and the second heat-radiating adhesive layer 19b is formed between the insulating sheet 20 and the bracket 3.

The heat-radiating adhesive can be automatically applied by a machine. Further, a heat-dissipation sheet that tends to tear and is difficult to handle is not used. Similarly to the heat-radiating adhesive, the insulating sheet 20 can be also assembled by automatic assembly. The shape of the insulating sheet 20 can be determined to any shape by in-line punching from a roll material.

If the first heat-radiating adhesive layer 19a or the second heat-radiating layer 19b peels off from a surface on which it is placed because of contraction when the heat-radiating adhesive is hardened, the peeling may adversely affect heat radiation. In the electric motor 1 according to the first embodiment, the insulating sheet 20 that is not restrained by any component is interposed between heat-radiating adhesives when the heat-radiating adhesives are hardened. When the insulating sheet 20 is restrained by any component, the heat-radiating adhesives contract when being hardened and a tensile force also acts on the insulating sheet 20, so that the hardened heat-radiating adhesives can easily peel off from the surface on which the adhesives are placed. However, the insulating sheet 20 in the electric motor 1 according to the first embodiment is not restrained by any component when the heat-radiating adhesives are being hardened. Therefore, the electric motor 1 according to the first embodiment can prevent the first heat-radiating adhesive layer 19a and the second heat-radiating adhesive layer 19b, obtained by hardening the heat-radiating adhesives, from peeling off from the bracket 3 or the heat sink 18, and can stably radiate heat.

The electric motor 1 according to the first embodiment does not require a component for fixing the insulating sheet 20, and therefore can prevent increase of the number of components and increase of assembly man-hours and can be assembled by automatic assembly.

### Second Embodiment

FIG. 3 is a cross-sectional view of a ventilating fan according to a second embodiment of the present invention. A ventilating fan 21 according to the second embodiment is provided with the electric motor 1 according to the first embodiment that is mounted in a housing 23, and a blower fan 22 is attached to the shaft 8. The ventilating fan 21 is installed above the ceiling through an opening in a ceiling board 25 and is covered by a grille 24 from below.

When power is supplied to the electric motor 1 and it is driven, a driving torque is generated and rotates the blower fan 22. When the blower fan 22 is rotated, an air flow indicated by an arrow A in FIG. 3 is generated. Since the electric motor 1 is in contact with the housing 23, heat generated by the power supply and driving of the electric motor 1 is transferred to the housing 23. Therefore, the ventilating fan 21 according to the second embodiment can radiate the heat generated in the electric motor 1 through the housing 23 while power is supplied to the electric motor 1 and it is driven.

The configurations described in the above embodiments are only examples of the content of the present invention. The configurations can be combined with other well-known techniques, and part of each of the configurations can be omitted or modified without departing from the scope of the present invention.

### REFERENCE SIGNS LIST

1 electric motor, 2 frame, 3 bracket, 4 stator, 5 iron core, 6 coil, 7 rotor, 8 shaft, 9 second bearing, 10 first bearing, 11, 12 housing, 13 board case, 14 output pin, 15 circuit board, 16 insulator, 17 heat-generating component, 18 heat sink, 19a first heat-radiating adhesive layer, 19b second heat-radiating adhesive layer, 20 insulating sheet, 21 ventilating fan, 22 blower fan, 23 housing, 24 grille, ceiling board.

1. An electric motor comprising:
a frame and a bracket to constitute an outer case;
a stator having a cylindrical shape accommodated in the frame;
a rotor arranged inner side of the stator;
a circuit board placed on a side of the stator which is close to the bracket;
a heat-generating component mounted on the circuit board; and
a heat sink mounted on the circuit board and thermally connected to the heat-generating component, wherein
a first heat-radiating adhesive layer, an insulating sheet, and a second heat-radiating adhesive layer are arranged between the bracket and the heat sink in this order from a side close to the heat sink, and the bracket and the heat sink are thermally connected to each other, wherein
the insulating sheet is not restrained by any component including the frame, the bracket, the stator, the rotor, the circuit board, the heat-generating component, and the heat sink, when heat-radiating adhesives are being hardened.

2. The electric motor according to claim 1, wherein an area of the insulating sheet is larger than an area of a surface of the heat sink on a side close to the bracket.

3. A ventilating fan comprising:
the electric motor according to claim 1; and
a blower fan driven to rotate by the electric motor.

4. A ventilating fan comprising:
the electric motor according to claim 2; and
a blower fan driven to rotate by the electric motor.
